(19) United States
(12) Patent Application Publication
(10) Pub. No.: US 2013/0339196 A1
(43) Pub. Date: Dec. 19, 2013

(54) ONLINE SHOPPING SYSTEM AND METHOD

(71) Applicant: M-MEDIA CO., LTD., TAIPEI CITY (TW)

(72) Inventors: GI GI CHEN, TAIPEI CITY (TW); SHIH JIEH HSU, TAIPEI CITY (TW)

(21) Appl. No.: 13/919,123

(22) Filed: Jun. 17, 2013

(30) Foreign Application Priority Data
Jun. 19, 2012 (TW) 101121971

(51) Int. Cl. G06Q 30/06

(52) U.S. Cl. CPC G06Q 30/0641
USPC 705/27.1

(57) ABSTRACT

An online shopping system and method in which an order unit selects from a shopping platform system the commodity to purchase and provides a receiver unit data, and then the shopping platform system uses the personal financial data of the order unit to apply to a payment unit for a billing-recognition payment data and finds out a membership corresponding code subject to the membership code of the membership card provided by the receiver unit so that a delivery unit can use a data reader to read the membership code and matching the membership code with the membership corresponding code and then handle the commodity to the receiver unit when matched, and at the same time, the deliver unit provides a confirmed signal to the shopping platform system to claim the payment unit to pay the money.

### FIELD OF THE INVENTION

The present invention relates to online shopping technology, particularly to an online shopping system and method, which is simple and convenient to perform and can improve transaction security.

### BACKGROUND OF THE INVENTION

Online shopping system, due to the advantages of its fastness, convenience, concealment and availability of diversified merchandise, the number of users or the amount of sales keeps growing explosively in recent years, and the size of its market is expanding year by year.

An online shopping system can be a network shopping system, TV shopping system, mobile electronic (cell phone) shopping system or planar shopping system (such as newspapers and magazines). The shopping flow of a regular online shopping system includes the following steps, as shown in FIG. 1.

Step S101: A consumer or subscriber uses the Internet, television or mobile phone to connect to a shopping platform to buy goods.

Step S102: After selection of the goods to buy, the subscriber checks out and selects the payment method, such as credit card payment, stored-value account transfer payment or cash-on-delivery payment.

Step S103: Confirm whether or not credit card payment is selected? If yes, then step S104, if not, proceed to step S113.

Step S104: The subscriber provides credit card data, such as credit card number, credit card expiry date and/or credit card verification code, and the shopping platform system provider, based on the credit card data, requests a payer, such as financial institution or credit card issuer, for payment directly.

Step S113 Confirm whether or not stored-value household payment, such as ATM (Automatic Teller Machine) transfer payment, credit card payment, prepaid card payment or stored-value card payment is selected? If yes, then step S114, if not, proceed to step S123.

Step S114: The subscriber transfers payment from the stored-value household account to the account assigned by the shopping platform in either online or offline.

Step S123: Selection of cash-on-delivery payment is confirmed.

Step S105: Confirm receiver data, such as receiver to be the subscriber, receiver name, receiver address, and/or receiving time.

Step S106: Has determined that the order is completed and ready to delivery issues.

Step S107: Delivery personnel delivers the purchased goods to the specified receiver address, and hands the goods to the receiver or receiving agent after recognition of the identification of the receiver or receiving agent, thus completing the online shopping procedure. In case of cash-on-delivery payment, the delivery personnel still needs to collect the payment from the receiver or receiving agent.

Although the aforementioned online shopping process is simple and convenient, but there are several shopping risks or disadvantages:

1. The subscriber's credit card account has been requested for payment in advance or the amount of the subscriber's stored-value account has been directly debited before the subscriber getting the purchased goods. If going to unsubscribe or to return the merchandise, the subscriber must go through a refund process. This is not only inconvenient, and will result in a loss of bank account interest.

2. Because it is difficult to request the receiver or receiving agent for identification recognition, goods sent to the delivery address may be falsely claimed, causing shopping disputes.

3. When an online purchase order is completed, the online shopping system may send a message or merchandise voucher to the subscriber or receiver, such as concert ticket. When the message of merchandise voucher is missing or illegally replicated, the commodity content could be unveiled, and the purchased goods may be stolen.

### SUMMARY OF THE PRESENT INVENTION

It is, therefore, the main object of the present invention to provide an online shopping system and method, which facilitates shopping convenience, enhances shopping safety level, and improves the drawbacks of conventional online shopping systems.

It is another object of the present invention to provide an online shopping system and method, which enables the delivery personnel to read the membership code of the membership card provided by the receiver by means of a data reader, facilitating quick recognition of the identification of the receiver, avoiding commodity pickup impersonally, and enhancing online shopping safety level.

It is still another object of the present invention to provide an online shopping system and method, which does not claim the financial organization, card issuer or stored-value account to pay the money before handing over the purchased commodity to the receiver, avoiding the troubles due to unsubscription or return of commodities, and protecting the subscriber against any bank interest loss.

The present invention provides an online shopping system, comprising: at least one order unit, each said order unit comprising an order device connectable to a network; at least one pickup unit, each said pickup unit comprising a membership card having set therein a membership code; a shopping platform system connected to said network, said shopping platform system comprising a merchandise display device, a member data processing device electrically connected to said merchandise display device and having stored therein a membership corresponding code corresponding to said membership code, and a fund processing device electrically connected to said merchandise display device, said merchandise display device being adapted to display a commodity selected through said order unit; a payment unit connected to said network, said payment unit comprising a financial data storage device and a payment processing device, said financial data storage device having stored therein a personal financial data of each person using said order unit; a delivery unit adapted to delivery each commodity selected through said order unit, said delivery unit comprising a data reader, said data reader comprising a display a reading device, a signal transmitter and a display device, said reading device being adapted for reading the membership code of said membership card, said signal transmitter being adapted for transmitting an object confirmed signal to said shopping platform system; and a data comparator installed in one of said data reader and said shopping platform system and adapted for matching the membership code fetched by said reading device with the membership corresponding code corresponding to the selected commodity.

The present invention provides an online shopping method, comprising the steps of: connecting an order unit to a shopping platform system to select a commodity to be purchased and to provide a pickup unit, said shopping platform system having stored therein a membership corresponding code for identifying said receiver unit; selecting a payment method through said order unit to provide a personal financial data to said shopping platform system; connecting said shopping platform system to a payment unit to obtain a pay code subject to said personal financial data and then to generate a billing-recognition payment data subject to the obtained pay code; said delivery unit carrying the selected commodity and a data reader to said pickup unit, and said pickup unit carrying a membership card having stored therein a membership code corresponding to said membership corresponding code; said data reader reading said membership code of said membership card of said pickup unit, and then said data reader or said shopping platform system matching said membership code with said membership corresponding code and then handing over the commodity to said pickup unit when the matching result matched; and said delivery unit transmitting an object confirmed signal to said shopping platform system, and then said shopping platform system transmitting said object confirmed signal to said payment unit to request for money payment for the delivered commodity.

In one embodiment of the present invention, wherein said order unit and said pickup unit are combined into an order and pickup unit.

In one embodiment of the present invention, wherein said data reader further comprises a data storage device adapted for storing the membership corresponding code corresponding to the selected commodity; said data comparator is built in said data reader for directly matching the membership code fetched by said data reader with the membership corresponding code corresponding to the selected commodity.

In one embodiment of the present invention, wherein said reading device of said data reader is selected from at least one of the group of wireless signal reader, optical signal reader, barcode scanner, infrared signal reader, contact type card reader, magnetic stripe reader, text symbol input reader and digital input reader.

In one embodiment of the present invention, wherein said membership card is provided by one of said receiver unit and said shopping platform system.

In one embodiment of the present invention, wherein said membership card is selected from the group of RFID (Radio-frequency identification) card, NFC (Near Field Communication) card, chip card, floppy disk card, digital card, symbol card or barcode label.

In one embodiment of the present invention, wherein said display device of said data reader is selected from the group of video display, audio player and optical indicator.

In one embodiment of the present invention, wherein said shopping platform system is selected from the group of network shopping system, TV shopping system, mobile electronic shopping system and planar shopping system; said network is selected from the group of Internet, LAN (local area network), telecommunication line, cable TV line, wireless communication line and planar network.

In one embodiment of the present invention, wherein said payment unit is one of the group of financial organizations, card issuers, joint credit information centers and stored-value card issuers.

In one embodiment of the present invention, wherein said fund processing unit of said shopping platform system has stored therein a billing-recognition payment data, said billing-recognition payment data comprising a pay code.

In one embodiment of the present invention, wherein said pay code is an authentication code or block data.

In one embodiment of the present invention, wherein the commodity selected through said order unit is a ticket; said data reader is a ticket machine.

In one embodiment of the present invention, wherein said pickup unit comprises an order code recognizable by said data comparator.

In one embodiment of the present invention, further comprising a sub step of checking whether or not said receiver unit having said membership card, and then requesting said order unit to provide a new pickup unit if negative.

In one embodiment of the present invention, wherein said payment method is a credit card payment or stored-value account transfer payment; said pay code is an authentication code or block data.

In one embodiment of the present invention, further comprising the steps of: enabling said shopping platform system to generate an order code after generation of said billing-recognition payment data and to transmit said order code to said receiver unit; and enabling said data reader to read said order code from said receiver unit and enabling one of said data reader and said shopping platform system to match the correctness of said order code.

### BRIEF DESCRIPTION OF THE DRAWINGS

FIG. 1 is a shopping flow chart of an online shopping system according to the prior art.

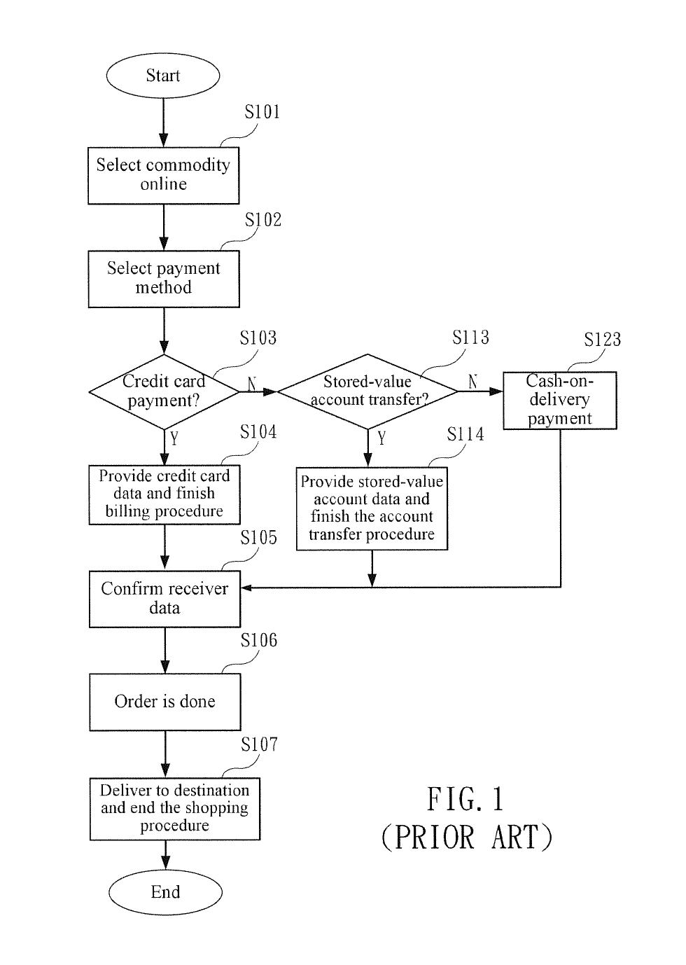

FIG. 2 is a block diagram of an online shopping system in accordance with a first embodiment of the present invention.

FIG. 3 is a shopping flow chart of an online shopping method used in the online shopping system in accordance with the first embodiment of the present invention (I).

FIG. 3A is a shopping flow chart of an online shopping method used in the online shopping system in accordance with the first embodiment of the present invention (II).

FIG. 4 is a block diagram of an online shopping system in accordance with a second embodiment of the present invention.

FIG. 5 is a shopping flow chart of an online shopping method used in the online shopping system in accordance with the second embodiment of the present invention.

### DETAILED DESCRIPTION OF THE PREFERRED EMBODIMENTS

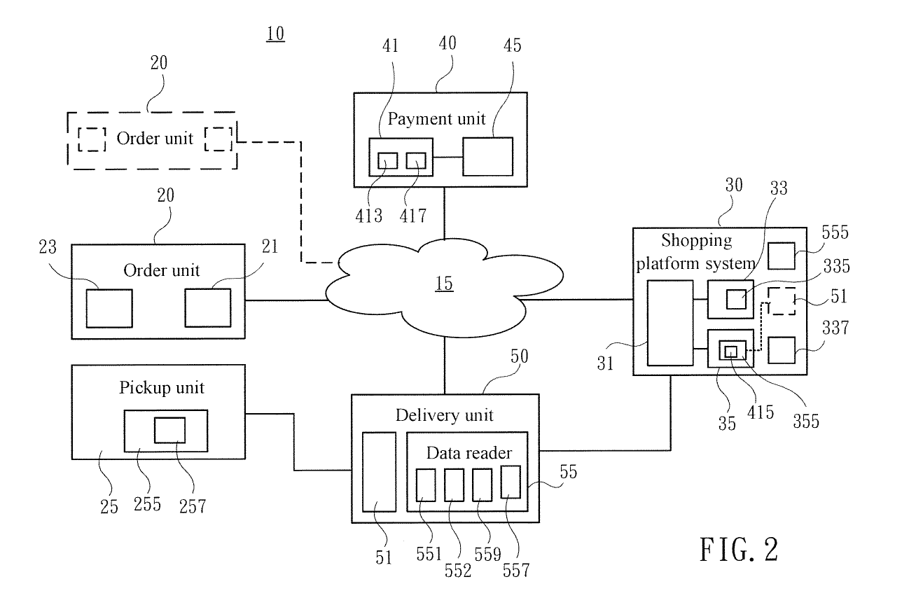

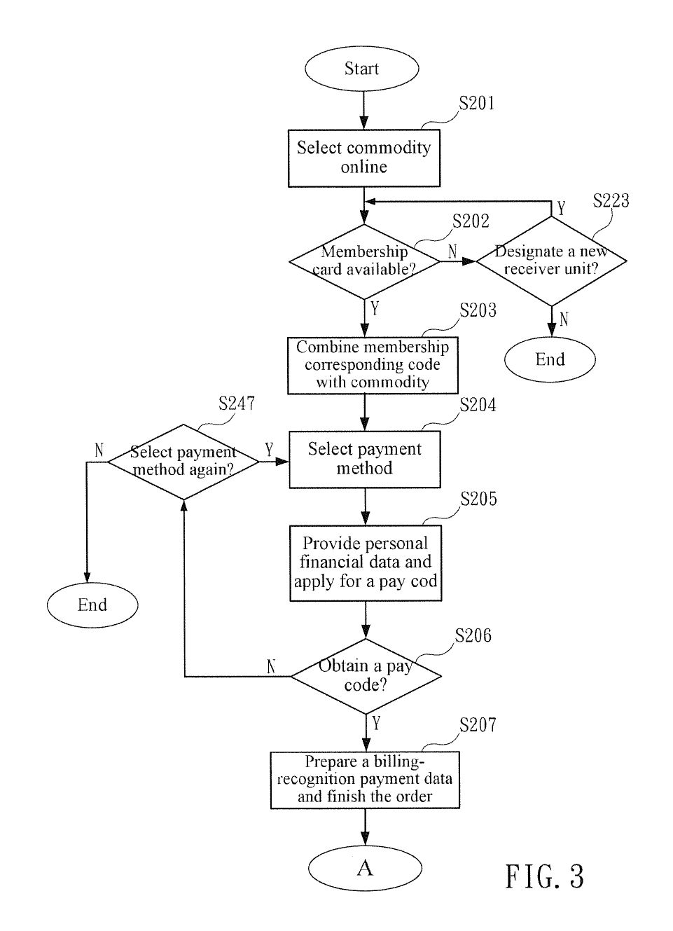

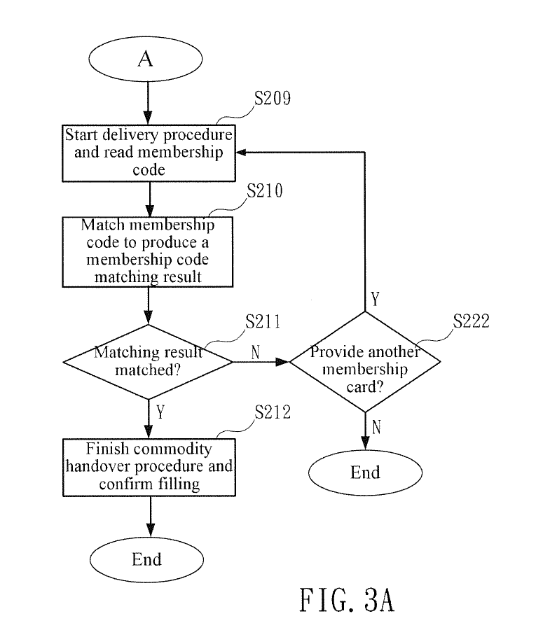

Please refer to FIG. 2, FIG. 3 and FIG. 3A, an online shopping system 10 in accordance with a first embodiment of the present invention is shown. The online shopping system 10 comprises at least one order unit 20, at least one pickup unit 25, a shopping platform system 30, a payment unit 40, and a delivery unit 50.

The order unit 20, the shopping platform system 30 and the payment unit 40 are respectively connected to a network 15, which can be the Internet, a LAN (local area network), a telecommunication line, a cable TV line, a wireless communication line, or a planar network (newspaper, magazine).

Step S201: When a consumer or the order unit 20 is going to purchase goods or services online, link an order device 21 of the order unit 20 to the network 15 to connect to the shopping platform system 30. The shopping platform system 30 can be a network shopping system, TV shopping system, mobile electronic shopping system or planar shopping system (such as newspaper or magazine shopping system).

The shopping platform system 30 comprises a merchandise display device 31 having electrically connected thereto a member data processing device 33 and a fund processing device 35. The merchandise display device 31 can display various selling goods or service items. The order unit 20 can select from the merchandise display device 31 the desired service commodities 51, such as physical commodities, securities or services.

Step S202: When going to check out after selection of the desired commodities 51 through the order unit 20, the shopping platform system 30 will request the order unit 20 to provide a pickup unit 25 and the related data, such as receiver name, receiver address, and/or receiving time, and inquire and confirm whether or not the pickup unit 25 obtains a membership card 255 that has been registered in the shopping platform system 30? If the pickup unit 25 obtains a membership card 255, proceed to step S203, if not, proceed to step S223.

The membership card 255 must be a physical card or entity tag that carries a membership code 257, such as RFID (Radio-frequency identification) card, NFC (Near Field Communication) card, chip card, floppy disk card, digital card, symbol card or barcode label. Further, the membership card 255 can be car issued by the shopping platform system provider or assigned related party, or a physical card of the pickup unit 25 itself, such as insurance card, credit card, debit card, EasyCard, iCash card, TaiwanMoney card, pay card, cash card, transportation card, Octopus card or stored-value card.

The shopping platform system 30 generates a membership corresponding code 335 subject to the membership code 257 during registration, and stores the membership corresponding code 335 in the membership data processing unit 33. The membership corresponding code 335 can be same as (consistent with) the membership code 257. Alternatively, the membership corresponding code 335 can be obtained through a calculation using the membership code 257. Thus, the membership corresponding code 335 can be regarded as a verification code of the membership code 257 for verifying the identity of the pickup unit 25.

In one embodiment of the present invention, the membership code 257 can be a serial data or other readable identification data stored in a RFID card, NFC card, chip card, floppy disk card, digital card, symbol card or barcode label.

Further, in another embodiment of the present invention, the symbol card or barcode label can be presented in the form of, for example, a one-dimensional bar code, 2-dimensional bar code or QR (quick response) code, or a label form that can be used as the membership code 257.

Step S223: The designated pickup unit 25 does not have a membership card 255, therefore, it must request the order unit 20 whether or not to re-assign a new pickup unit 25? If yes, select a new pickup unit 25, and then proceed to step S202. On the contrary, if the order unit 20 cannot assign a new pickup unit 25 or the number of times in changing a new pickup unit 25 has reached a set number of times (N times); it must end the online shopping procedure regretfully.

Step S203: The shopping platform system 30 fetches the membership corresponding code 335 subject to the pickup unit 25, and combines or records the selected commodity 51 with the fetched membership corresponding code 335. In other words, the membership corresponding code 335 is like a merchandise voucher of the pickup unit 25 for exchanging the purchased commodity 51.

Step S204: Request the order unit 20 to select the payment method to be credit card payment or stored-value account transfer payment.

In one embodiment of the present invention, the stored-value householder can be an ATM (automatic teller machine), or a valuable card, such as credit card, debit card, EasyCard, iCash card, transportation card, Octopus card, prepaid card or stored-value card that has stored therein cash equivalent values.

Step S205: The order unit 20 provides a personal financial data 23, such as credit card data or stored-value account transfer data, to the shopping platform system 30; the shopping platform system 30 uses the received personal financial data 23 to apply to the payment unit 40 for a pay code 415 that can be an authentication code or a block data equivalent to the value of the purchased commodity.

The aforementioned personal financial data 23 refers to the provision of the card number, validity date and/or back digital code of a credit card or stored-value card, or a scheduled transfer procedure made by the order unit 20 directly online or offline.

The payment unit 40 can be a financial organization (bank), card issuer (for example, credit card issuer), joint credit information center (such as credit card center) or stored-value card issuer, comprising a financial data storage device 41 and a payment processing device 45. The financial data storage device 41 has stored therein the personal financial data 413 of the user or subscriber 20, such as financial amount of deposit, credit limit, available credit limit, and/or name.

Step S206: The shopping platform system 30 confirms receipt of the pay code 415 of authentication code or block data? If yes, proceed to step S207, or if not, proceed to step S247.

Step S207: The order unit 20 has a stored value or available credit limit sufficient to pay for the purchased commodity 51 and other related costs, thus, the shopping platform system 30 will, based on the received personal financial data 23 and pay code 415, produce a billing-recognition payment data 355 and store the data in the fund processing device 35 to complete the order procedure

The billing-recognition payment data 355 enables the shopping platform system 30 to request the payment unit 40 to pay or transfer the money immediately after the purchased commodity 51 has been safely handed over to the pickup unit 25 but not before delivery of the purchased commodity 51 to the pickup unit 25, protecting the order unit 20 against any bank interest loss and avoiding the troubles due to unsubscription or return of commodities.

Step S247: The personal financial data 23 provided by the order unit 20 is insufficient to pay for the purchased commodity 51 and other related costs, thus, ask the order unit 20 whether or not to select another payment method? If yes, return to step S204; if not, or the number of times in changing payment method has reached the set number of times (N times), end this online shopping procedure regretfully.

Step S209: The shopping platform system 30 instructs or entrusts a delivery unit 50 to start a delivery procedure, and the delivery unit 50 will carry a data reading device 55 with the purchased commodity 51. The delivery unit 50 or the shopping platform system 30 will obtain in advance the delivery time and destination of the purchased commodity 51 from the pickup unit 25 or the order unit 20, and the pickup unit 25 (either the subscriber, appointed receiver or other agent) will carry the membership card 255 to pick up the purchased commodity 51.

The data reader 55 comprises at least one reading device 551, a signal transmitter 557, and a display device 559. The reading device 551 can be a wireless signal reader, optical signal reader, barcode scanner, infrared signal reader, contact type card reader, magnetic stripe reader, text symbol input reader and/or digital input reader for reading the membership code 257 in the membership card 255. The display device 559 can be a video display, audio player and/or optical indicator.

After obtained the membership code 257 from the membership card 255, the signal transmitter 557 of the data reader 55 sends the membership code 257 to the shopping platform system 30 through the network 15.

Step S210: A built-in data comparator 555 of the shopping platform system 30 matches the obtained membership code 257 to be in line with (or same as) the fetched membership corresponding code 335 or not, and then provides a membership code matching result 337 to the delivery unit 50.

Step S211: The deliver unit 50 obtains the membership code matching result 337 from display device 559, and then proceed to step S212 if the matching result is in line with each other, or step S222, if not.

Step S222: The membership card 255 provided by the pickup unit 25 is not the originally authorized membership card, and thus, the pickup unit 25 is requested to provide a membership card 255 again. If the pickup unit 25 can provide a membership card 255 again, return to step S209, enabling the data reader 55 to read the newly provided membership card 255. If the pickup unit 25 cannot provide a membership card 255 again, or the membership card reading times is over a set number of times (N times), end the handover procedure and this online shopping procedure.

Step S212: The membership card 255 provided by the pickup unit 25 is the originally authorized membership card, and thus, the delivery procedure can be done. When handing over the purchased commodity 51 to the pickup unit 25, the delivery unit 50 will also transfer an object confirmed signal 552 to the shopping platform system 30. After obtained the object confirmed signal 552, the shopping platform system 30 immediately drive the fund processing device 35 to transfer the prepared billing-recognition payment data 355 to the payment unit 40, requesting the payment processing device 45 of the payment unit 40 to pay money for the purchased commodity 51 subject to the pay code 415. At this time, the whole online shopping procedure is done.

Because the membership corresponding code 335 is equivalent to a merchandise voucher of the purchased commodity 51 and stored in the shopping platform system 30, the invention effectively reduces the troubles due to missing or illegal replication of the merchandise voucher.

Further, the membership card 255 and the membership code 257 can be rapidly read and checked by the data reader 55, and therefore, the identity of the pickup unit 25 can be rapidly examined, enhancing commodity delivery safety.

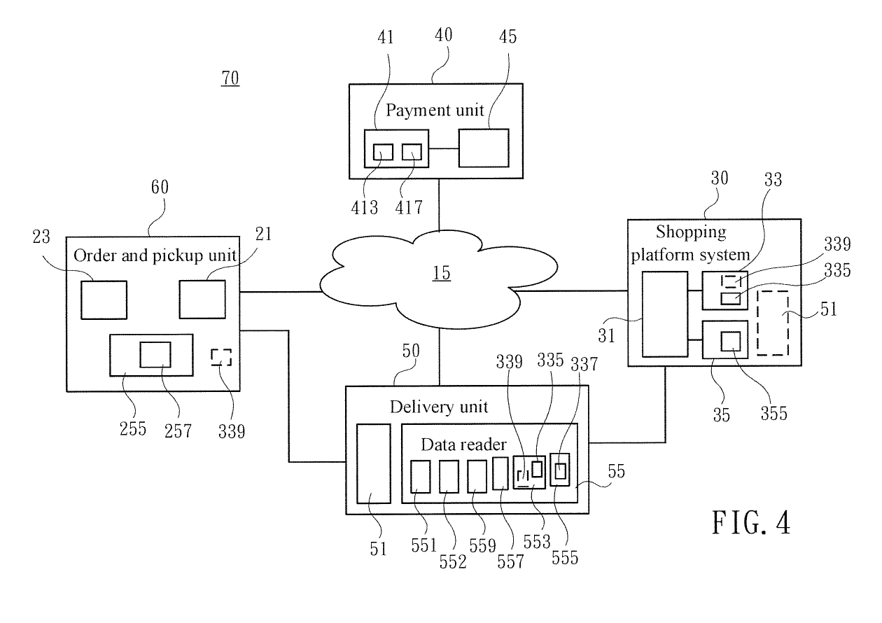

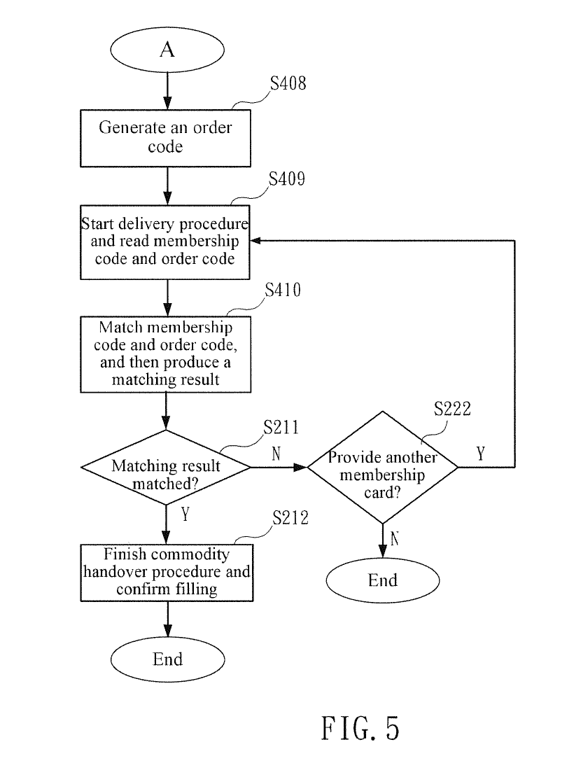

FIGS. 4 and 5 illustrate a second embodiment of the present invention. According to this second embodiment, the online shopping system 70 comprises an order and pickup unit 60, which is a combination of the order unit 20 and pickup unit 25 of the aforesaid first embodiment of the present invention.

Further, the data reader 55 of the delivery unit 50 in this second embodiment further comprises a data storage device 553 and a data comparator 555. The data storage device 553 is adapted for storing each membership corresponding code 335 corresponding to each respective purchased commodity 51, membership card 255, and membership code 257.

When reading the membership code 257, the data reader 55 needs not to transfer the fetched membership code 257 to the shopping platform system 30 and can match the fetched membership code 257 with the respective membership code 335 by its built-in data comparator 55 to produce a membership code matching result 337.

According to this second embodiment, the online shopping method, after the step S207 shown in FIG. 3, further comprises the following steps:

Step S408 in between step S207 and step S209: The shopping platform system 30 generates an order code 339 after order procedure. This order code 339 can be an ID code of the order and pickup unit 60, cell phone number or any personal identification number, or a random number generated by the shopping platform system 30.

The order code 339 will be stored in the membership data processing device 33 of the online shopping platform system 30 and/or the data storage device 553 of the delivery unit 50, and transferred to the order and pickup unit 60 by means of a SMS (short message service) or through the network 15.

Step S409 to substitute for Step S209 shown in FIG. 3A: The shopping platform system 30 instructs or entrusts a delivery unit 50 to start a delivery procedure, and the delivery unit 50 will carry a data reading device 55 with the purchased commodity 51. The order and pickup unit 60 will carry the membership card 255 to pick up the purchased commodity 51.

Step S410 to substitute for Step S210 shown in FIG. 3A: The data reader 55 reads the membership code 257 of the pickup unit 25 and requests the order and pickup unit 60 to provide the order code 339 or to key in the order code 339 through the data reader 55. The order code 339 will be sent to the shopping platform system 30, or matched by the data comparator 555 of the data reader 55 directly.

In this second embodiment, the online shopping system 70, in addition to the aforesaid membership code 257 and membership corresponding code 335 matching procedure, will also perform an extra order code 339 matching procedure, enhancing the ID recognition of the order and pickup unit 60 and online shopping safety level.

When the shopping platform system 30 sells a precious high price commodity and obtains an order, the delivery unit 50 will carry multiple purchased commodities 51, for example, three ruby jewelry pieces for selection by the order and pickup unit 60, enabling the consumer to enjoy an over-the-counter purchase. At this time, the matching of the membership code 257 with the membership corresponding code 335 and the order code 339 matching procedure disclosed highlight their importance. Through the double identity recognition and matching procedure, the shopping safety of this online shopping method is enhanced.

Further, the purchased commodity 51 can be a ticket, for example, admission ticket, entrance ticket, transportation ticket, etc. In this case, the delivery unit 50 is a check-up unit at the entrance, and the data reader 255 is a ticket machine.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An online shopping system, comprising:
at least one order unit, each said order unit comprising an order device connectable to a network;
at least one pickup unit, each said pickup unit comprising a membership card having set therein a membership code;
a shopping platform system connected to said network, said shopping platform system comprising a merchandise display device, a member data processing device electrically connected to said merchandise display device and having stored therein a membership corresponding code corresponding to said membership code, and a fund processing device electrically connected to said merchandise display device, said merchandise display device being adapted to display a commodity selected through said order unit;
a payment unit connected to said network, said payment unit comprising a financial data storage device and a payment processing device, said financial data storage device having stored therein a personal financial data of each person using said order unit;
a delivery unit adapted to delivery each commodity selected through said order unit, said delivery unit comprising a data reader, said data reader comprising a display a reading device, a signal transmitter and a display device, said reading device being adapted for reading the membership code of said membership card, said signal transmitter being adapted for transmitting an object confirmed signal to said shopping platform system; and
a data comparator installed in one of said data reader and said shopping platform system and adapted for matching the membership code fetched by said reading device with the membership corresponding code corresponding to the selected commodity.

2. The online shopping system as claimed in claim 1, wherein said order unit and said pickup unit are combined into an order and pickup unit.

3. The online shopping system as claimed in claim 1, wherein said data reader further comprises a data storage device adapted for storing the membership corresponding code corresponding to the selected commodity; said data comparator is built in said data reader for directly matching the membership code fetched by said data reader with the membership corresponding code corresponding to the selected commodity.

4. The online shopping system as claimed in claim 1, wherein said reading device of said data reader is selected from at least one of the group of wireless signal reader, optical signal reader, barcode scanner, infrared signal reader, contact type card reader, magnetic stripe reader, text symbol input reader and digital input reader.

5. The online shopping system as claimed in claim 1, wherein said membership card is provided by one of said receiver unit and said shopping platform system.

6. The online shopping system as claimed in claim 1, wherein said membership card is selected from the group of RFID (Radio-frequency identification) card, NFC (Near Field Communication) card, chip card, floppy disk card, digital card, symbol card or barcode label.

7. The online shopping system as claimed in claim 1, wherein said display device of said data reader is selected from the group of video display, audio player and optical indicator.

8. The online shopping system as claimed in claim 1, wherein said shopping platform system is selected from the group of network shopping system, TV shopping system, mobile electronic shopping system and planar shopping system; said network is selected from the group of Internet, LAN (local area network), telecommunication line, cable TV line, wireless communication line and planar network.

9. The online shopping system as claimed in claim 1, wherein said payment unit is one of the group of financial organizations, card issuers, joint credit information centers and stored-value card issuers.

10. The online shopping system as claimed in claim 1, wherein said fund processing unit of said shopping platform system has stored therein a billing-recognition payment data, said billing-recognition payment data comprising a pay code.

11. The online shopping system as claimed in claim 10, wherein said pay code is an authentication code or block data.

12. The online shopping system as claimed in claim 1, wherein the commodity selected through said order unit is a ticket; said data reader is a ticket machine.

13. The online shopping system as claimed in claim 1, wherein said pickup unit comprises an order code recognizable by said data comparator.

14. An online shopping method, comprising the steps of:
connecting an order unit to a shopping platform system to select a commodity to be purchased and to provide a pickup unit, said shopping platform system having stored therein a membership corresponding code for identifying said receiver unit;
selecting a payment method through said order unit to provide a personal financial data to said shopping platform system;
connecting said shopping platform system to a payment unit to obtain a pay code subject to said personal financial data and then to generate a billing-recognition payment data subject to the obtained pay code;
said delivery unit carrying the selected commodity and a data reader to said pickup unit, and said pickup unit carrying a membership card having stored therein a membership code corresponding to said membership corresponding code;
said data reader reading said membership code of said membership card of said pickup unit, and then said data reader or said shopping platform system matching said membership code with said membership corresponding code and then handing over the commodity to said pickup unit when the matching result matched; and
said delivery unit transmitting an object confirmed signal to said shopping platform system, and then said shopping platform system transmitting said object confirmed signal to said payment unit to request for money payment for the delivered commodity.

15. The online shopping method as claimed in claim 14, further comprising a sub step of checking whether or not said receiver unit having said membership card, and then requesting said order unit to provide a new pickup unit if negative.

16. The online shopping method as claimed in claim 14, wherein said payment method is a credit card payment or stored-value account transfer payment; said pay code is an authentication code or block data.

17. The online shopping method as claimed in claim 14, wherein said data reader comprises a reading device, a signal transmitter and a display device, said reading device being adapted for reading the membership code of said membership card, said display device being selected from the group of video display, audio player and optical indicator, said reading device being selected from the group of wireless signal reader, optical signal reader, barcode scanner, infrared signal reader, contact type card reader, magnetic stripe reader, text symbol input reader and digital input reader.

18. The online shopping method as claimed in claim 14, wherein said order unit and said pickup unit are combined into an order and pickup unit.

19. The online shopping method as claimed in claim 14, wherein said data reader further comprises a data storage device adapted for storing the membership corresponding code corresponding to the selected commodity; said data comparator is built in said data reader for directly matching the membership code fetched by said data reader with the membership corresponding code corresponding to the selected commodity.

20. The online shopping system as claimed in claim 14, wherein said membership card is provided by one of said receiver unit and said shopping platform system.

21. The online shopping system as claimed in claim 14, wherein said membership card is selected from the group of RFID (Radio-frequency identification) card, NFC (Near Field Communication) card, chip card, floppy disk card, digital card, symbol card or barcode label.

22. The online shopping system as claimed in claim 14, wherein said shopping platform system is selected from the group of network shopping system, TV shopping system, mobile electronic shopping system and planar shopping system; said network is selected from the group of Internet, LAN (local area network), telecommunication line, cable TV line, wireless communication line and planar network.

23. The online shopping system as claimed in claim 14, wherein said payment unit is one of the group of financial organizations, card issuers, joint credit information centers and stored-value card issuers.

24. The online shopping system as claimed in claim 14, wherein the commodity selected through said order unit is a ticket; said data reader is a ticket machine.

25. The online shopping system as claimed in claim 14, further comprising the steps of:
enabling said shopping platform system to generate an order code after generation of said billing-recognition payment data and to transmit said order code to said receiver unit; and
enabling said data reader to read said order code from said receiver unit and enabling one of said data reader and said shopping platform system to match the correctness of said order code.
